(19) United States
(12) Patent Application Publication
(10) Pub. No.: US 2011/0270599 A1
(43) Pub. Date: Nov. 3, 2011

(54) METHOD FOR TESTING INTEGRATED CIRCUIT AND SEMICONDUCTOR MEMORY DEVICE

(76) Inventor: Heat-Bit PARK, Gyeonggi-do (KR)

(21) Appl. No.: 13/092,694

(22) Filed: Apr. 22, 2011

(30) Foreign Application Priority Data
Apr. 29, 2010 (KR) 10-2010-0039887
Feb. 28, 2011 (KR) 10-2011-0017647

(51) Int. Cl. G06F 17/50

(52) U.S. Cl. 703/15

(57) ABSTRACT

A method for testing an integrated circuit includes simulating the integrated circuit and generating waveforms of signals at a plurality of nodes of the integrated circuit, generating a text file representing the signal waveforms by detecting a waveform change of the signals, and analyzing the text file.

### CROSS-REFERENCES TO RELATED APPLICATIONS

The present application claims priority of Korean Patent Application Nos. 10-2010-0039887 and 10-2011-0017647, filed on Apr. 29, 2010 and Feb. 28, 2011, respectively, which are incorporated herein by reference in their entirety.

### BACKGROUND

1. Field

Exemplary embodiments of the present invention relate to a method for testing whether an integrated circuit and a semiconductor memory device normally operate or not.

2. Description of the Related Art

After an integrated circuit is designed, the integrated circuit is tested to check whether it operates normally or not.

In general, in order to test an integrated circuit, the logic of a full chip is inputted to a simulator, and several hundred different data and signal patterns, which may be generated when the chip actually operates, are simulated. Then, the result file of the simulation is used to determine whether the integrated circuit is properly designed or not.

However, it is not easy to analyze the simulation result file. Furthermore, every operation of the simulation may not be checked due to a lack of engineering skills or adequate time.

For example, after a semiconductor memory device is designed, various patterns of data may be simulated and repeatedly written/read to test the semiconductor memory device. That is, it may be determined whether the data are properly written/read or not. In this case, a Verilog-based tool, for example, Turbo Wave or Sand Work, may be used to obtain the waveform of a signal on each node inside the chip, and the waveform may be analyzed to check the write/read operations of the memory device.

Meanwhile, a file comprising waveforms, which is obtained by simulating a semiconductor memory device, is complicated. In order to determine whether the chip properly operates or not by verifying the waveforms one by one, a lot of time is consumed. Here, the accuracy of the determination result may be low.

### SUMMARY

An embodiment of the present invention is directed to a method for analyzing a result file, obtained by simulating an integrated circuit, which is capable of reducing the test time of the integrated circuit and reducing a cost consumed for the test.

In accordance with an embodiment of the present invention, a method for testing an integrated circuit includes: simulating the integrated circuit and generating waveforms of signals at a plurality of nodes of the integrated circuit; generating a text file representing the signal waveforms by detecting a waveform change of the signals; and analyzing the text file.

In accordance with another embodiment of the present invention, a method for testing a memory device, which performs read and write operations, includes: simulating the read and write operations in the memory device and generating waveforms of signals at a plurality of nodes of the memory device; generating a text file representing the waveforms by detecting a waveform change of the signals; and analyzing the text file to determine whether first data inputted during the write operation is identical to second data outputted during the read operation.

### BRIEF DESCRIPTION OF THE DRAWINGS

FIG. 1 is a diagram illustrating a waveform showing the transition of a signal A, which is obtained as a result of simulation.

FIG. 2 is a diagram illustrating a waveform showing transitions of signals A, B, and C, which is obtained as a result of simulation.

FIG. 3 is a flow chart showing a method for testing an integrated circuit in accordance with an embodiment of the present invention.

FIG. 4 is a timing diagram showing a process in which a command and data corresponding to the command are inputted to the integrated circuit and operation result data of the integrated circuit is outputted.

FIG. 5 is a flow chart showing a method for testing a memory device in accordance with another embodiment of the present invention.

FIG. 6 is a timing diagram showing write and read operations of the memory device.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

First, a method for exporting a waveform of a signal obtained as a result of simulation into a text file in accordance with an embodiment of the present invention will be described.

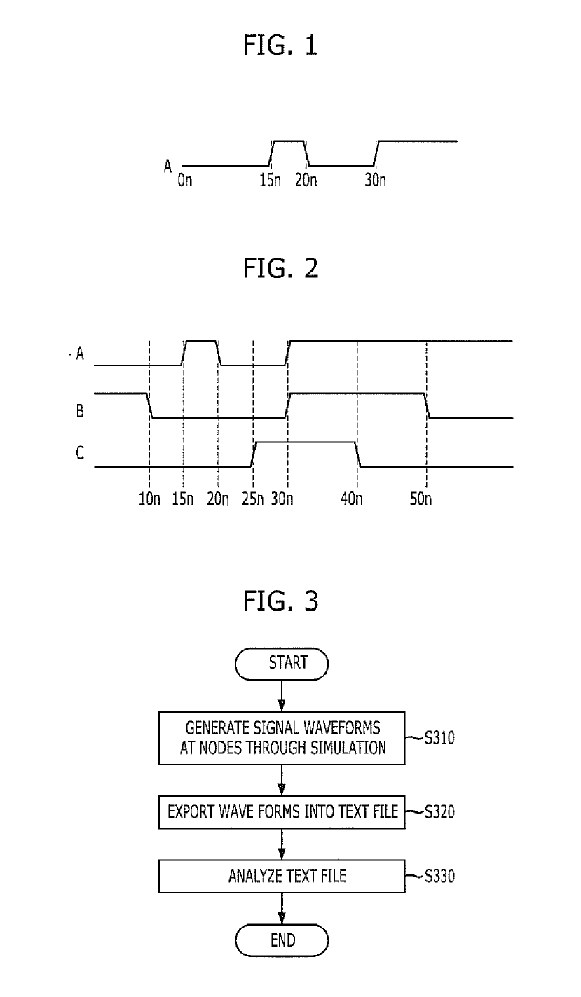

FIG. 1 is a diagram illustrating a waveform of a signal obtained as a result of simulation, where the waveform shows the transitions of a signal A.

When a result file including information as to the result of the simulation is loaded by using such a tool as Sand Work or Turbo Wave, the signal waveform of FIG. 1 is obtained. Here, the result file is an image file having information as to how the signal A changes.

In the embodiment of the present invention, in exporting a signal waveform into a text file, the following rules may apply: (1) to include information as to a time and a state of a signal, and (2) to record the state of the signal whenever the transition of the signal occurs, i.e., a sampling.

When the waveform of FIG. 1 is exported into a text file by complying with the rules (1) and (2), the text file may be represented as follows.

##### Text File of Signal A

0 n, 0

15 n, 0.5

15.1 n, 1

20 n, 0.5

20.1 n, 0

30 n, 0.5

30.1 n, 1

#####

In the text file of the signal A, 0 n, 15 n, and so on at the left column represent the time values in unit of nano seconds (ns or n), and 0, 0.5, and 1 at the right column represent different logic values of the signal A. Referring to the text file, it can be seen that new information is recorded in the text file only when the logic value of the signal A is changed (that is, only when an event for changing the logic value of the signal A occurs). According to an example, the logic values of the signal A may be simply divided into 0 and 1. According to another example, the logic values of the signal A may be divided into 0, a predetermined value such as 0.5, and 1. When the logic values of the signal A are divided into 0, 0.5, and 1, at the point of time that the signal A changes may be accurately represented. For example, when the level of the signal A starts to change at 14.9 n, and the signal A has a level of logic 0.5 at 15 n and a level of logic 1 at 15.1 n, 15 n corresponds to a time point that the logic value of the signal A changes.

FIG. 2 is a diagram illustrating signal waveforms showing transitions of signals A, B, and C.

For the signal waveforms of FIG. 2, the following rules can be applied for exporting the signal waveforms into a text file.

The rules are as follows: (1) to include information as to time and a state of a signal and (2) to record the state of the signal whenever a transition of the signal occurs. While the rule (1) may apply to a single signal as described above in connection with FIG. 1, rule (1) may also apply to several signals in FIG. 2 where information as to time and states of all the signals may be included in the text file. As to the rule (2), whenever any one of the signals changes, the states of all the signals inclusive of the changed one may be recorded.

When the signal waveform of FIG. 2 is exported into a text file in a state by complying with the rules (1) and (2), the text file may be represented as follows.

##### Text File of Signals A, B, and C

0 n, 0, 1, 0

10 n, 0, 0.5, 0

10.1 n, 0, 0, 0

15 n, 0.5, 0, 0

15.1 n, 1, 0, 0

20 n, 0.5, 0, 0

20.1 n, 0, 0, 0

25 n, 0, 0, 0.5

25.1 n, 0, 0, 1

30 n, 0.5, 0.5, 1

30.1 n, 1, 1, 1

40 n, 1, 1, 0.5

40.1 n, 1, 1, 0

50 n, 1, 0.5, 0

50.1 n, 1, 0, 0

#####

The text file of the signals A, B, and C sequentially represents the time, the logic level of the signal A, the logic level of the signal B, and the logic level of the signal C from the leftmost column to the rightmost column. Whenever an event for changing the logic levels of one or more signals among the signals A to C occurs, the event is recorded in the text file. Therefore, the text file includes all the information on the signals A, B, and C. The state of a signal at a point of time may be quickly figured out through such a test file when testing an integrated circuit.

FIG. 3 is a flow chart showing a method for testing an integrated circuit in accordance with an embodiment of the present invention.

Referring to FIG. 3, the method for testing an integrated circuit includes a first step S310 of simulating the integrated circuit to generate waveforms of signals at a plurality of nodes; a second step S320 of generating a text file by obtaining information as to time positions at which the signals on the signal waveform change; and a third step S330 of analyzing the text file.

In the first step S310, selected ones of a plurality of nodes are used in the test among the available nodes of the integrated circuit. The integrated circuit includes several thousand to several hundred thousand nodes. All the nodes of the integrated circuit do not need to be used in the test. To determine whether the integrated circuit normally operates or not, information on commands applied to the integrated circuit and inputted/outputted data (signals) may be used. In the first step, nodes relevant to desired information are sampled. Through the simulation of the integrated circuit, the waveforms of the signals are obtained at the plurality of nodes. Such an operation may be performed by a variety of Verilog-based tools such as Turbo Wave and Sand Work.

In the second step S320, the signal waveforms obtained in the first step S310 are exported into a text file. The exporting of the signal waveforms into the text file may be performed in such a manner as shown in FIGS. 1 and 2. The text file includes all information as to the signal waveforms at the plurality of nodes.

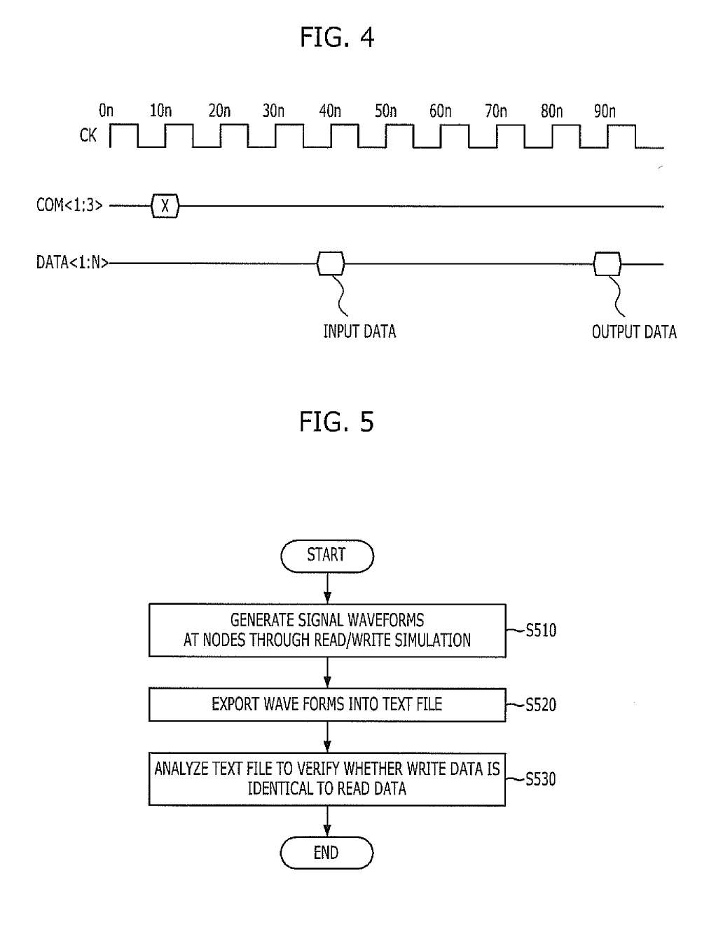

In the third step S330, the text file is analyzed to determine whether the integrated circuit operates properly. Since the text file includes all the information on the signals at the plurality of nodes, whether the integrated circuit operates properly or not may be easily determined by analyzing the text file. Furthermore, since the levels to which the signals change and the times at which the signals change are simultaneously recorded in the text file, a search for a field required for analyzing the operation of the integrated circuit may be quickly made. The third step S330 will be described in detail with reference to FIG. 4.

FIG. 4 is a timing diagram showing a process in which a command and data corresponding to the command are inputted to the integrated circuit and operation result data of the integrated circuit is outputted.

In FIG. 4, CK represents a system clock signal, COM<1:3> represents signals at three nodes of the integrated circuit to which commands are inputted, and DATA<1:N> represents N-bit data inputted to and outputted from the integrated circuit. Furthermore, the period of the system clock signal CK is supposed to be 10 n.

First, a command X is applied to the integrated circuit at time 10 n. After the lapse of three clocks from the application of the command X, that is, at time 40 n, N-bit data INPUT DATA corresponding to the command X are applied. Then, the integrated circuit processes the N-bit data INPUT DATA in accordance with the command X. The time taken from an input timing of the command X to an input timing of the N-bit data INPUT DATA corresponding to the command X is defined in accordance with a latency rule of the integrated circuit. In this embodiment, the latency is supposed to be three clocks.

And then, the output data OUTPUT DATA processed by the integrated circuit is outputted after the lapse of eight clocks from the application time of the command X (that is, at time 90 n). After the input data INPUT DATA is inputted in response to the command X, the output data OUTPUT DATA obtained by processing the input data INPUT DATA is also outputted in accordance with the latency rules of the integrated circuit. According to an example, the latency is eight clocks.

Hereinafter, a method for analyzing whether the integrated circuit operates properly or not by using the text file, that is, the third step S330 of FIG. 3 will be described in detail.

First, a point of time at which the command X is applied is searched for in the text file. The application time of the command X may be searched for by determining whether or not a specific pattern of signal is inputted to the nodes COM<1:3> to which commands are inputted. For example, if commands are inputted to three nodes COM<1:3>, the logic values of the nodes COM<1:3> may be (1, 0, 1), respectively, when the command X is applied. In this case, a point of time at which the logic values of the nodes COM<1:3> are set to (1, 0, 1), respectively, in the text file may be searched for. In FIG. 4, the point of time at which the command X is applied corresponds to 10 n.

Since the point of time at which the command X is applied is determined, input data INPUT DATA corresponding to the command X is searched for. As described above, the time at which the input data INPUT DATA corresponding to the command X is inputted is decided in accordance with the latency rule of the integrated circuit. In such a case as shown in FIG. 4, where the latency of the input data INPUT DATA is set to three clocks, a logic level of the input data INPUT DATA is sampled for being recorded in the text file at 40 n point on the system clock CK, which is a time point on the system clock CK after a lapse of 30 n from the application of the command X at the 10 n system clock point.

After that, the output data OUTPUT DATA which is generated when the integrated circuit processes the input data INPUT DATA in response to the command X is searched for. The time at which the output data OUTPUT DATA corresponding to the command X is outputted is decided in accordance with the latency rule of the integrated circuit. In such a case as shown in FIG. 4, where the latency of the output data OUTPUT DATA is set to eight clocks, a logic level of the output data OUTPUT DATA is sampled for being recorded in the text file at 90 n point on the system clock CK, which is a time point on the system clock CK after a lapse of 80 n from the application of the command X at the 10 n system clock point.

Through the above-described process, an input of the command X to the integrated circuit and input data inputted to the integrated circuit in correspondence to the command X are detected. Also, output data OUTPUT DATA outputted by processing the input data INPUT DATA inputted to the integrated circuit in response to the command X is detected. Therefore, it may easily figure out whether the integrated circuit carries out the operation in response to the command X properly or not.

For example, if the command X is an addition command and the input data INPUT DATA are 3 and 2, a determination as to whether the output data OUTPUT DATA is 5 or not is made to determine whether the integrated circuit operates without an error in response to the command X.

In the text file, the information (logic) of the nodes (signals) and the times are recorded together. Therefore, the text file is used to easily figure out a logic level of a specific node at a specific time, and facilitates searching for such data. Therefore, when the above-described method using a text file is used to perform a test, the test time may be significantly reduced.

FIG. 5 is a flow chart showing a method for testing a memory device in accordance with another embodiment of the present invention.

Referring to FIG. 5, the method for testing a memory device includes a first step S510 of simulating read and write operations in the memory device to generate waveforms of the signals at the plurality of nodes; a second step S520 of generating a text file from the waveforms by sampling information as to positions at which the signals on the waveforms change; and a third step S530 of analyzing the text file to check whether or not data inputted during the write operation is identical to data outputted during the read operation. Here, the read and write operations are performed in response to the same address.

In the first step S510, the plurality of nodes are related to the read and write operations among a number of nodes of the memory device. The nodes related to the read and write operations refer to nodes which are required for verifying the read and write operations. Therefore, command nodes CASB, RASB, CSB, and WEB to which a clock signal CK and read and write commands are applied, nodes to which addresses are inputted, and nodes to and from which data are inputted and outputted may becomes the plurality of nodes. In the first step S510, such an operation may be performed by using a variety of Verilog-based tools such as Turbo Wave and Sand Work. Here, CASB represents Column Address Strobe, RASB represents Row Address Strobe, CSB represents Chip Select, and WEB represents Write Enable.

In the second step S520, the signal waveforms obtained in the first step S510 is exported into a text file. The exporting of the signal waveforms into the text file may be performed in such a manner as shown in FIGS. 1 and 2. The text file includes all information on the signals at the nodes related to the read and write operations and selected as the test target nodes.

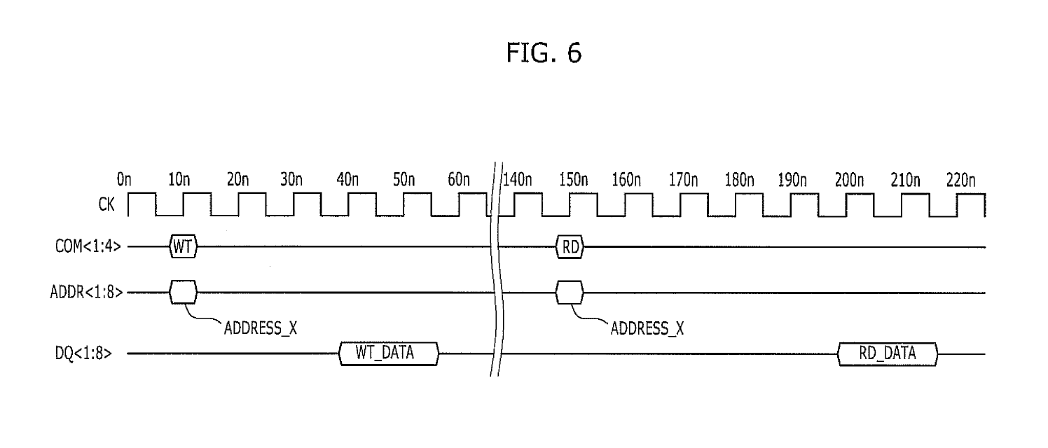

In the third step S530, the text file is analyzed to check whether or not data inputted during the write operation is identical to data outputted during the read operation. As a matter of course, by using the same address, data written during the write operation is read during the read operation, and whether or not the written data coincides with the read data is determined. When the written data and the read data are identical to each other, it may be determined that the memory device normally operates. This case may be referred to as a pass determination. When the written data and the read data are different from each other, it may be determined that the memory device does not operate normally. This case may be referred to as a fail determination. The third step S530 will be described in detail with reference to FIG. 6.

FIG. 6 is a timing diagram showing the write and read operations of the memory device.

In FIG. 6, CK represents a clock signal, COM<1:4> represents commands CASB, RASB, CSB, and WEB of the memory device, ADDR<1:8> represents an address inputted through eight address nodes of the memory device, and DQ<1:8> represents data inputted and outputted through eight data nodes of the memory device.

First, a write command WT is applied to the memory device at 10 n, and simultaneously, an address ADDRESS_X is applied. After the lapse of a time (30 n) corresponding to CAS write latency (CWL), that is, at 40 n time point on the clock signal CK, write data WT_DATA are inputted through the data nodes. Here, the CWL is supposed to be three clocks.

Then, a read command RD is applied to the memory device at time 150 n, and simultaneously, the address ADDRESS_X is applied. After the lapse of a time corresponding to CAS latency (CL), read data RD_DATA are outputted through the data nodes. Here, the CL is supposed to be five clocks.

Hereinafter, the method for analyzing whether the memory device normally operates or not by using a text file, that is, the third step S530 of FIG. 5 will be described in detail.

First, the point of time at which the write command WT is applied is searched for in the text file. The point of time at which the write command WT is applied corresponds to a point of time when CASB=0, RASB=1, CSB=0, and WEB=0 at an edge of the clock signal. Therefore, a point of time when CK=0.5, CASB=0, RASB=1, CSB=0, and WEB=0 may be searched for in the text file. In FIG. 6, it may be determined that the write command WT is applied at 10 n time point of the clock signal CK. With the application of the write command WT, the logic value of the address may be checked. That is, it is desirable to determine which logic value the address ADDRESS_X has at the point of time (10 n) at which the write command WT is applied.

After a time corresponding to the CWL passes from the application time of the write command WT, write data WT_DATA are inputted through data nodes. Since the write command WT is applied at 10 n time point on the clock signal CK and the CWL is 30 n, the logic values of the data nodes at 40n time point on the clock signal CK may be checked in the text file. Then, write data WT_DATA input in response to the application of the write command WT may be determined.

Now, a point of time at which the read command RD is applied is searched for in the text file. The point of time at which the read command RD is applied corresponds to a point of time when CASB=0, RASB=1, CSB=0, and WEB=1 in an edge of the clock signal. Therefore, a point of time when CK=0.5, CASB=0, RASB=1, CSB=0, and WEB=1 may be searched for in the text file. Furthermore, it should be determined whether or not the address applied with the read command RD is identical to the address ADDRESS_X applied with the write command WT. In FIG. 6, it may be checked that the application time of the read command RD is 150 n time point on the clock signal CK and the same address as the address ADDRESS_X applied with the write command WT is applied with the read command RD.

The reason that the address applied with the read command RD should be identical to the address applied with the write command WT may be explained as follows. During the test, whether the memory device normally operates or not may be checked by determining whether or not the data is written into the memory device and read from the memory device as it is. That is, it may be determined whether or not the written data WT_DATA is identical to a read data RD_DATA. If the address applied with the write command RD is different from the address applied with the read command WT, the write data WT_DATA cannot be identical to the read data RD_DATA, even though the memory device normally operates.

After a time corresponding to the CL passes from the application time of the read command RD, the read data RD_DATA are outputted through the data nodes. Since the application time of the read command RD is 150 n time point on the clock signal CK and the CL is 50 n, the logic values of the data nodes at 200 n time point of the clock signal CK may be checked in the text file so as to determine which read data RD_DATA is outputted.

Finally, the write data WT_DATA and the read data RD_DATA are compared. When the write data WT_DATA and the read data RD_DATA are identical to each other, it means that the read and write operations of the memory device are normally performed. This case may be referred to as a pass determination. On the other hand, when the write data is different from the read data, it means that the read and write operations of the memory device are abnormally performed. This case may be referred to as a fail determination.

In accordance with the embodiments of the present invention, a signal waveform is generated by simulating an integrated circuit, and a test file is generated by including information on when logic levels of the signals on the waveform change. Since the text file includes the information on a time and logic value of signals at the time, if the text file is analyzed during the test of the integrated circuit, whether the integrated circuit operates normally or abnormally may be easily determined. Furthermore, the efficiency of the test may be increased.

Further, in accordance with the embodiments of the present invention, a simple text file, which is generated by extracting essential information from a complex signal waveform generated as a result of simulation of an integrated circuit, is used to test the integrated circuit. Accordingly, it may also increase the efficiency of the test.

While the present invention has been described with respect to the specific embodiments, it will be apparent to those skilled in the art that various changes and modifications may be made without departing from the spirit and scope of the invention as defined in the following claims.

What is claimed is:

1. A method for testing an integrated circuit, comprising:
simulating the integrated circuit and generating waveforms of signals at a plurality of nodes of the integrated circuit;
generating a text file representing the signal waveforms by detecting a waveform change of the signals; and
analyzing the text file.

2. The method of claim 1, wherein the text file comprises information as to a position at which one of the signals changes in logic level among a logic low level, an intermediate logic level, and a logic high level.

3. The method of claim 2, wherein the intermediate logic level has a corresponding voltage level between a voltage level corresponding to the logic low level and a voltage level corresponding to the logic high level.

4. The method of claim 1, wherein the text file comprises information as to time points at which the signals change and logic values of the signals at the time points.

5. The method of claim 1, wherein the text file comprises information as to a time point at which any one of the signals changes and logic values of the signals at the time point.

6. The method of claim 1, wherein the plurality of nodes comprises a node to which a clock signal is inputted, nodes to which commands are inputted, and nodes to and from which data are inputted and outputted.

7. The method of claim 1, wherein the analyzing of the text file comprises:
detecting an input timing of a command;
detecting data inputted in response to the command after a first latency from an input timing of the command;
detecting data outputted in response to the command after a second latency from the input timing of the command; and
analyzing the inputted data and the outputted data to determine whether an error has occurred.

8. The method of claim 1, wherein logic level changes of all the signals at a time point are represented in the text file when a logic level of at least one of the signals changes at the time point.

9. A method for testing a memory device which performs read and write operations, the method comprising:
simulating the read and write operations in the memory device and generating waveforms of signals at a plurality of nodes of the memory device;
generating a text file representing the waveforms by detecting a waveform change of the signals; and
analyzing the text file to determine whether first data inputted during the write operation is identical to second data outputted during the read operation.

10. The method of claim 9, wherein the read and write operations are simulated using the same address.

11. The method of claim 9, wherein the text file comprises information as to as to a position at which one of the signals changes in logic level among a logic low level, an intermediate logic level, and a logic high level.

12. The method of claim 11, wherein the intermediate logic level has a corresponding voltage level between a voltage level corresponding to the logic low level and a voltage level corresponding to the logic high level.

13. The method of claim 9, wherein the text file comprises information as to a time point at which any one of the signals changes and logic values of the signals at the time point.

14. The method of claim 9, wherein the plurality of nodes comprises a node to which a clock signal is inputted, nodes to which commands are inputted, nodes to which addresses are inputted, and nodes to and from which the first and second data are inputted and outputted, respectively.

15. The method of claim 9, wherein the analyzing of the text file comprises:
verifying whether a write command is applied to the memory device or not;
checking the first data inputted in response to the write command;
verifying whether a read command is applied to the memory device or not;
checking the second data outputted in response to the read command; and
determining whether or not the first data is identical to the second data.

16. The method of claim 15, wherein whether the write command is applied to the memory device is verified by checking that a column address strobe node, a row address strobe node, a chip select node, and a write enable node have a logic low level, a logic high level, logic low level, and logic low level, respectively, at an edge of a clock signal received at a clock node as indicated by the text file.

17. The method of claim 15, wherein the first data is checked by checking logic values at data input/output nodes after a latency from an input timing of the write command.

18. The method of claim 15, wherein whether the read command is applied to the memory device is verified by checking that a column address strobe node is a logic low level, a row address strobe node is a logic high level, a chip select node is a logic low level, and a write enable node is a logic high level at an edge of a clock signal received at a clock node as indicated by the text file.

19. The method of claim 15, wherein the second data is checked by checking logic values at data input/output nodes after a latency from an input timing of the read command.

20. The method of claim 9, wherein logic levels of all the signals a time point are represented in the text file when a logic level of at least one of the signals changes at the time point.
